(19) United States
(12) Patent Application Publication
(10) Pub. No.: US 2016/0261024 A1
(43) Pub. Date: Sep. 8, 2016

(54) Antenna Structure with Bracket Antenna and Methods for Use Therewith

(71) Applicant: Broadcom Corporation, Irvine, CA (US)

(72) Inventors: Henrik Tholstrup Jensen, Long Beach, CA (US); Zhijiang Dong, Beijing (CN)

(73) Assignee: BROADCOM CORPORATION, Irvine, CA (US)

(21) Appl. No.: 14/674,053

(22) Filed: Mar. 31, 2015

Related U.S. Application Data
(60) Provisional application No. 62/127,887, filed on Mar. 4, 2015.

(51) Int. Cl. H01Q 1/24; H04M 1/02; H04W 4/00; H01Q 1/50

(52) U.S. Cl. CPC H01Q 1/243; H01Q 1/50; H04M 1/026; H04W 4/008

(57) ABSTRACT

An antenna section includes a bracket antenna configured to send and receive RF communications of a mobile communication device having a back side that is enclosed by a back cover, wherein the bracket antenna forms a structural portion of the back cover of the mobile communication device that encloses at least one portion of an edge of the mobile communication device and at least one portion of the back side. A booster plate is coupled to the mobile communication device and is configured to electromagnetically interact with the bracket antenna to modify the antenna beam pattern.

### CROSS REFERENCE TO RELATED PATENTS

The present U.S. Utility Patent Application claims priority pursuant to 35 U.S.C. §119(e) to U.S. Provisional Application No. 62/127,887, entitled “ANTENNA STRUCTURE WITH BRACKET ANTENNA AND METHODS FOR USE THEREWITH”, filed Mar. 4, 2015, which is hereby incorporated herein by reference in its entirety and made part of the present U.S. Utility Patent Application for all purposes.

### BACKGROUND

1. Technical Field

Various embodiments relate generally to wireless communication and more particularly to communication devices that support near-field communications.

### Description of Related Art

Communication systems are known to support wireless and wireline communications between wireless and/or wireline communication devices. Such communication systems range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, RFID, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), Long Term Evolution (LTE) systems and/or other wireless standards.

Wireless communications occur within licensed or unlicensed frequency spectrums. For example, wireless local area network (WLAN) communications occur within the unlicensed Industrial, Scientific, and Medical (ISM) frequency spectrum of 900 MHz, 2.4 GHz, and 5 GHz.

BRIEF DESCRIPTION OF THE SEVERAL VIEWS OF THE DRAWING(S)

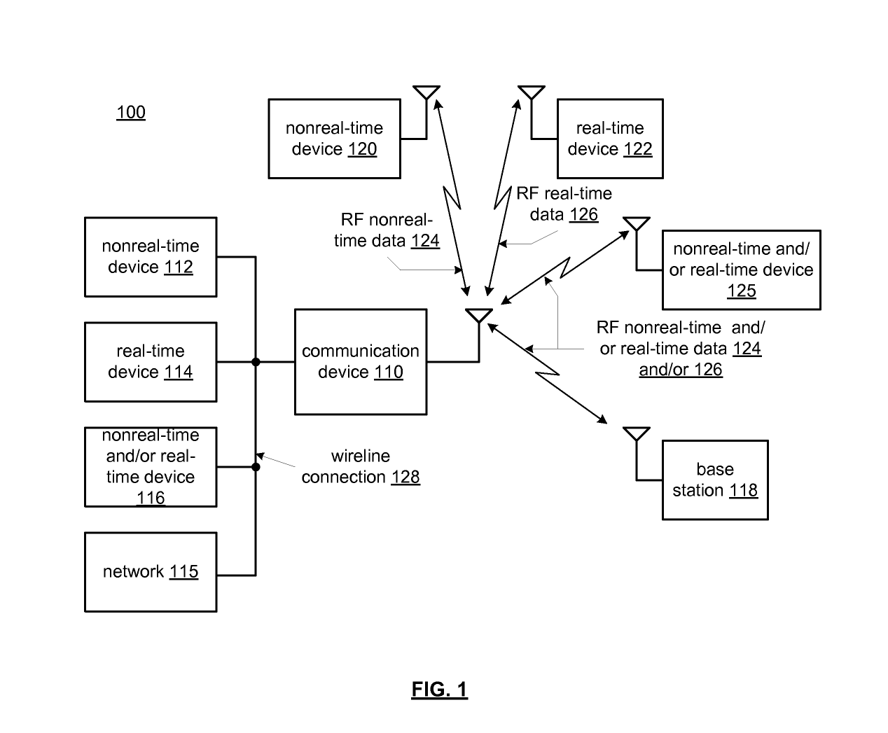

FIG. 1 is a schematic block diagram of an embodiment of a wireless communication system 100;

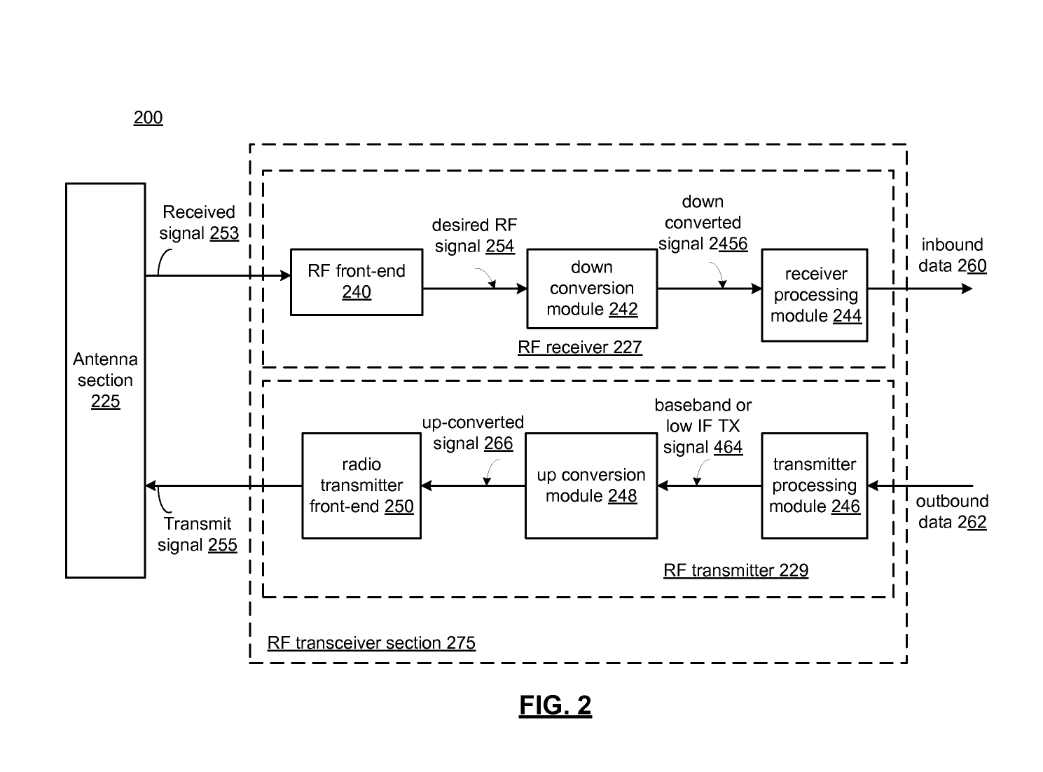

FIG. 2 is a schematic block diagram of an embodiment of a wireless radio 200;

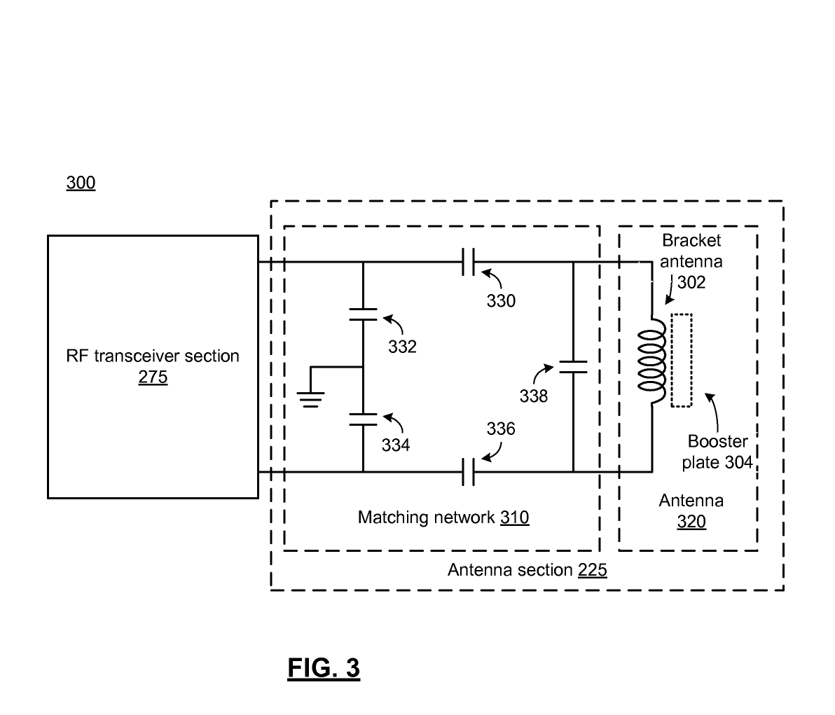

FIG. 3 is a schematic block diagram of an embodiment of an antenna section 225;

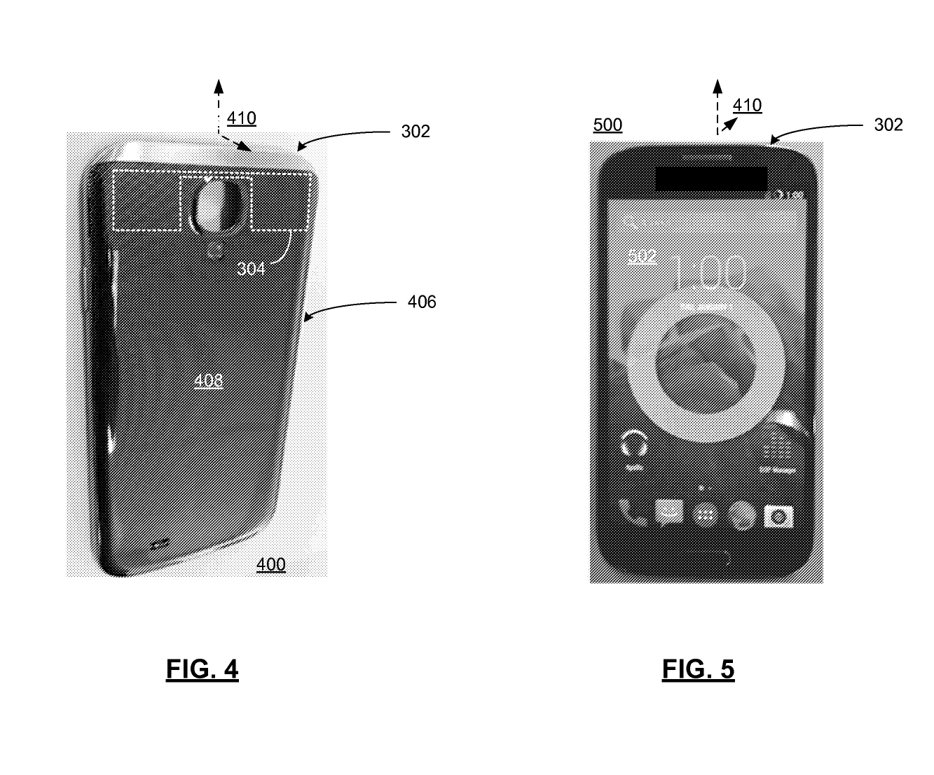

FIG. 4 is a pictorial and schematic representation 400 of a back view of an embodiment of a mobile communication device;

FIG. 5 is a pictorial representation 500 of a front view of an embodiment of a mobile communication device;

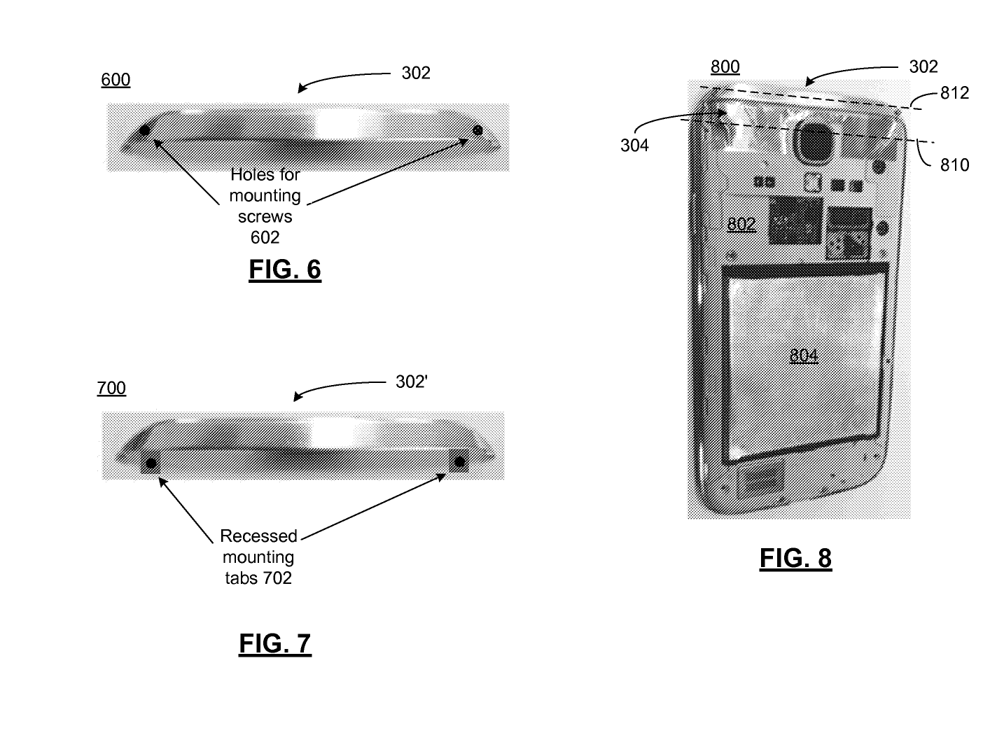

FIG. 6 is a pictorial representation 600 of a front view of an embodiment of a bracket antenna;

FIG. 7 is a pictorial representation 700 of a front view of another embodiment of a bracket antenna;

FIG. 8 is a pictorial representation 800 of a back view of an embodiment of a mobile communication device;

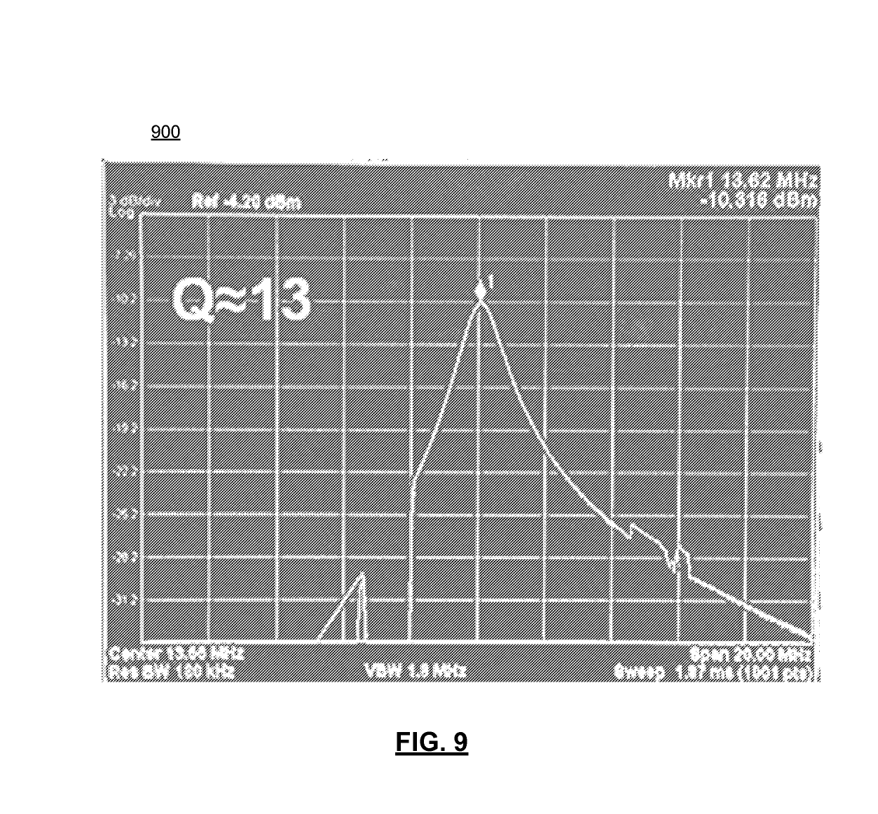

FIG. 9 is a graphical representation 900 of an antenna frequency response of an embodiment; and

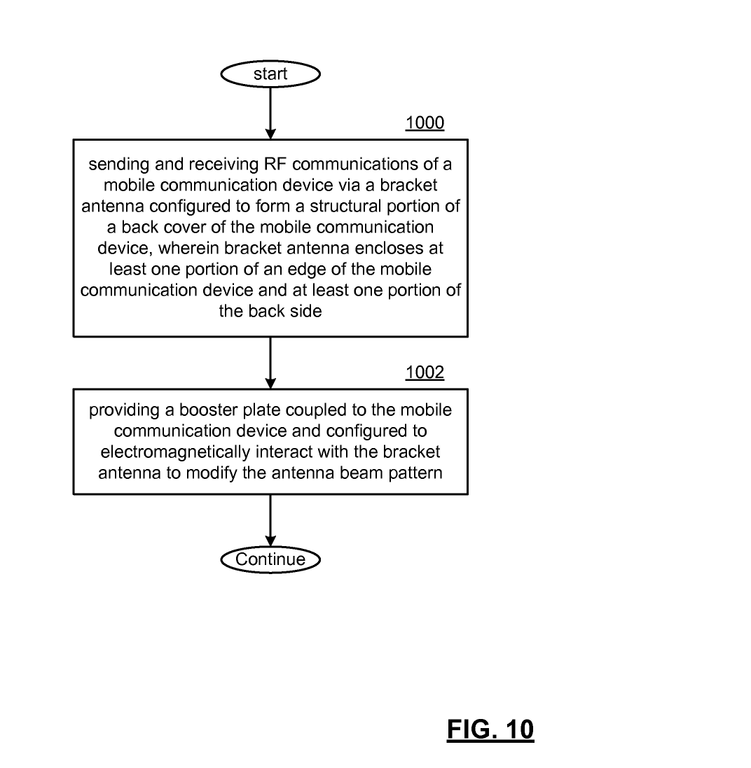

FIG. 10 is a flow diagram of an embodiment of a method.

### DETAILED DESCRIPTION

FIG. 1 is a schematic block diagram of an embodiment of a wireless communication system 100. In particular a wireless communication system 100 is shown that includes a communication device 110 that communicates real-time data 126 and/or non-real-time data 124 wirelessly with one or more other devices such as base station 118, non-real-time device 120, real-time device 122, and non-real-time and/or real-time device 125. In addition, communication device 110 can also optionally communicate over a wireline connection with network 115, non-real-time device 112, real-time device 114, non-real-time and/or real-time device 116.

In an embodiment the wireline connection 128 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as WiHD, WiGig, NGMS, IEEE 802.11a, ac, ad, b, g, n, or other 802.11 standard protocol, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Long term Evolution (LTE), Personal Communication Services (PCS), Radio Frequency Identification (RFID), Near-field Communications (NFC) or other mobile wireless protocol or other wireless communication protocol, either standard or proprietary. Further, the wireless communication path can include multiple transmit and receive antennas, as well as separate transmit and receive paths that use single carrier modulation to bi-directionally communicate data to and from the communication device 110.

Communication device 110 can be a mobile communication device such as a cellular telephone, a local area network device, personal area network device or other wireless network device, a personal digital assistant, tablet, phablet, game console, personal computer, laptop computer, or other device that performs one or more functions that include communication of voice and/or data via the wireless communication path. Further communication device 110 can be an access point, base station, NFC reader or other network access device that is coupled to a network 115 such as the Internet or other wide area network, either public or private, via wireline connection 128. In an embodiment, the real-time and non-real-time devices 112, 114, 116, 120, 122 and 125 can be personal computers, laptops, PDAs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 126 includes voice, audio, video and multimedia applications including Internet gaming, etc. The non-real-time data 124 includes text messaging, email, web browsing, file uploading and downloading, electronic payments such as electronic wallet application data, electronic ticket application data, micro-location application data, personal authorization or identification application data, RF tag identification or location data, object identification tracking or location data, inventory control data, shopping application data, etc.

In an embodiment, the communication device 110 includes an RF transceiver that includes an antenna section with a bracket antenna that includes one or more features or functions of the various embodiments that are described in greater detail in association with FIGS. 2-10 that follow.

FIG. 2 is a schematic block diagram of an embodiment of a wireless radio 200. In particular, the wireless radio 200 includes an antenna section 225, and an RF transceiver section 275 having an RF receiver 227 and RF transmitter 229. The RF receiver 227 includes a RF front end 240, a down conversion module 242 and a receiver processing module 244. The RF transmitter 229 includes a transmitter processing module 246, an up conversion module 248, and a radio transmitter front-end 250.

In particular, the RF transmitter 229 generates a transmit signal 255 that is sent via antenna section 225 to a remote communication device. The transmit signal 255 is generated by RF transmitter 229 based on modulation of outbound data 262. In operation, the RF transmitter 229 receives outbound data 262. The transmitter processing module 246 packetizes outbound data 262 in accordance with a communication protocol, either standard or proprietary, to produce baseband or low intermediate frequency (IF) transmit (TX) signals 264 that includes an outbound symbol stream that contains outbound data 262. The baseband or low IF TX signals 264 may be digital baseband signals (e.g., have a zero IF) or digital low IF signals, where the low IF typically will be in a frequency range of one hundred kilohertz to a few megahertz. Note that the processing performed by the transmitter processing module 246 can include, but is not limited to, scrambling, encoding, puncturing, mapping, modulation, and/or digital baseband to IF conversion.

The up conversion module 248 includes a digital-to-analog conversion (DAC) module, a filtering and/or gain module, and a mixing section. The DAC module converts the baseband or low IF TX signals 264 from the digital domain to the analog domain. The filtering and/or gain module filters and/or adjusts the gain of the analog signals prior to providing it to the mixing section. The mixing section converts the analog baseband or low IF signals into up-converted signals 266 based on a transmitter local oscillation.

The radio transmitter front end 250 includes a power amplifier and may also include a transmit filter module. The power amplifier amplifies the up-converted signals 266 to produce transmit signal 255 which may be filtered by a transmitter filter module, if included.

The RF receiver 227 generates inbound data 260 based on a received signal 253 received from the remote communication device via antenna section 225. The received signal 253 is amplified and optionally filtered by the RF front-end 240 that generates a desired RF signal 254. The down conversion module 242 includes a mixing section, an analog to digital conversion (ADC) module, and may also include a filtering and/or gain module. The mixing section converts the desired RF signal 254 into a down converted signal 256 that is based on a receiver local oscillation, such as an analog baseband or low

IF signal. The ADC module converts the analog baseband or low IF signal into a digital baseband or low IF signal. The filtering and/or gain module high pass and/or low pass filters the digital baseband or low IF signal to produce a baseband or low IF signal 256 that includes an inbound symbol stream. Note that the ordering of the ADC module and filtering and/or gain module may be switched, such that the filtering and/or gain module is an analog module.

The receiver processing module 244 processes the baseband or low IF signal 256 in accordance with a communication protocol, either standard or proprietary, to produce inbound data 260. The processing performed by the receiver processing module 244 can include, but is not limited to, digital intermediate frequency to baseband conversion, equalization, demodulation, demapping, depuncturing, decoding, and/or descrambling.

In an embodiment, the receiver processing module 244 and transmitter processing module 246 can be implemented via use of a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip. Such a memory device may be a read-only memory, random access memory, volatile memory, non-volatile memory, static memory, dynamic memory, flash memory, and/or any device that stores digital information. Note that when the processing devices implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry. While the receiver processing module 244 and transmitter processing module 246 are shown separately, it should be understood that these elements could be implemented separately, together through the operation of one or more shared processing devices used for baseband processing of multiple RF sections or in any other combination of separate and/or shared processing.

In operation, the RF transmitter 229 and RF receiver 227 operate in the same frequency band, such as single carrier modulation with the same carrier frequency or multi-carrier modulation having spectra that have the same or similar frequency channels, that may or may not otherwise use the same the frequency band. The antenna section 225 includes a bracket that is configurable for transceiving of the transmit signal 255 and the received signal 253. In one example of operation, the RF transceiver section 275 operates in conjunction with antenna section 225 to send and receive signals in accordance with near-field communications (NFC). The antenna section 225 includes optional functions and features that are described in greater detail in association with FIGS. 3-10 that follow.

FIG. 3 is a schematic block diagram of an embodiment of an antenna section 225. The antenna section 225 includes an antenna 320 having a bracket antenna 302 and the booster plate 304. The bracket antenna 302 is configured to send and receive RF communications of a mobile communication device, such as a mobile communication device 110, via the RF transceiver section 275. The booster plate 304 is coupled to the mobile communication device and configured to electromagnetically interact with the bracket antenna 302 to modify the antenna beam pattern of the antenna 320 to, for example, produce a directionalized beam or other desired pattern.

A matching network 310 is configured to couple the antenna 320 to the RF transceiver section 275, for example, to support near-field communication. The matching network shown includes capacitors 330, 332, 334, 336 and 338. It should be understood however, that other matching networks such as L-C networks, Pi-networks, L-networks and other network can provide impedance matching between the antenna 320 and the RF transceiver section 275. Further, while a differential antenna configuration is shown, a single ended antenna configuration with the other end of the antenna 320 being grounded is likewise possible to, for example, mitigate effects caused by a user coming in direct contact with the bracket antenna 302.

Examples of the bracket antenna 302 and/or the booster plate 304, including several optional functions and features, are presented in conjunction with FIGS. 4-10 that follow.

FIG. 4 is a pictorial and schematic representation 400 of a back view of an embodiment of a mobile communication device. In this configuration, the mobile communication device is an example of mobile communication device 110 discussed in conjunction with FIG. 1. The mobile communication device has a back side that is enclosed by a back cover 406, for example, in a clamshell fashion. The back cover has a back plate and a rim that surrounds, in whole or in part, the outer edge of the mobile communication device. The bracket antenna 302 forms a portion of the rim.

In the example shown, the bracket antenna 302 forms an exposed structural portion of the back cover 406 of the mobile communication device that encloses at least one portion of an edge of the mobile communication device and at least one portion of the back side. In particular, the bracket antenna 302 encloses the top edge of the mobile communication device, part of the back side of the mobile communication device and small portions of the top right and top left edges of the mobile communication device in the orientation shown. The back cover 406 includes a black plastic non-antenna portion 408 that snaps into place so as to mate with the bracket antenna 302 such that, together, the non-antenna portion 408 and bracket antenna 302 substantially cover all of the four edges and substantially cover the back side of the mobile communication device 400.

The booster plate 304 is coupled to the mobile communication device and covered by the non-antenna portion of the back cover 406. As discussed in conjunction with FIG. 3, the booster plate 304 is coupled to the mobile communication device and configured to electromagnetically interact with the bracket antenna 302 to produce a desired pattern, such as a beam pattern that has a main lobe that points predominately upward from the top edge and/or backward from the top back edge of the mobile communication device, as indicated, for example, by the arrows 410.

FIG. 5 is a pictorial representation 500 of a front view of an embodiment of a mobile communication device. In this configuration, the mobile communication device is an example of communication device 110 discussed in conjunction with FIG. 1. The mobile communication device is a mobile telephone having a display screen 502. In the example shown, the bracket antenna 302 encloses the top edge of the mobile communication device when the display screen 502 is in a portrait orientation as a shown.

As discussed in conjunction with FIGS. 3 and 4, a booster plate, such as booster plate 304, is coupled to the mobile communication device and configured to electromagnetically interact with the bracket antenna 302 to produce a desired pattern, such as a beam pattern that has a main lobe that points predominately upward from the top edge and/or backward from the top back edge of the mobile communication device, as indicated, for example, by the arrows 410.

Consider an example where the mobile communication device includes a payment application, a shopping application or other application that uses the bracket antenna 302 to support near-field communications. When the user of the mobile communication device launches the application and holds the phone in portrait mode as shown, the mobile communication device can communicate with a NFC reader or tag that is positioned in the directions indicated by arrows 410 from the top or the back of the mobile communication device.

FIG. 6 is a pictorial representation 600 of a front view of an embodiment of a bracket antenna. In particular, bracket antenna 302 is shown, un-mounted from the mobile communication device. Holes for mounting screws 602 are provided that clamp down connecting wires and further for attaching the bracket antenna 302 to the mobile communication device, for example to an inner back portion of the mobile communication device, such as on a plastic inner back cover. In an embodiment, the bracket antenna is made of a hard aluminum alloy, such as alloy 7075 with a composition that composition includes approximately 5.6-6.1% zinc, 2.1-2.5% magnesium, 1.2-1.6% copper, and less than half a percent of silicon, iron, manganese, titanium, chromium, and other metals, however, other 7000 series aluminum alloys such as 7050, 7175, 7178, 7150 with various tempers such as T76511, T76, T74511, T73511, T77, T73, T76511, T6, F, 0, etc. can likewise be employed as well as other series of aluminum alloys and/or other metals.

FIG. 7 is a pictorial representation 700 of a front view of another embodiment of a bracket antenna. In particular, another embodiment of bracket antenna 302, referred to as 302′, is shown un-mounted from the mobile communication device. This embodiment is similar to the embodiment of FIG. 6, however, recessed mounting tabs 702 are included to accept screws to clamp down connecting wires and further for attaching the bracket antenna 302′ to the mobile communication device, for example to an inner back portion of the mobile communication device, such as on a plastic inner back cover. In this example, the mounting tabs 702 are recessed so as to be hidden behind a plastic back cover, such as the non-antenna portion of the back cover 408 presented in conjunction with FIG. 4.

It should be noted that while FIGS. 4-7 have presented bracket antenna 302 and 302′ with a particular shape, other brackets of alternative shapes can likewise be employed as well as simple wire antennas of similar shape and that are covered by a back cover rather than be exposed.

FIG. 8 is a pictorial representation 800 of a back view of an embodiment of a mobile communication device. In this representation, the non-antenna portion of the back cover 408 presented in conjunction with FIG. 4 has been removed exposing the battery 804 and a plastic inner back cover 802. As shown, the bracket antenna 302 is mounted to the plastic inner back cover 802. The booster plate 304 is formed of a metal foil member that is adhered to the plastic inner back cover 802 via an adhesive. However, in other embodiments, the booster plate can be mounted directly to the non-antenna portion of the back cover 408 presented in conjunction with FIG. 4 in a corresponding position. The booster plate 304 has a longitudinal axis 810 that is offset from and substantially parallel to the longitudinal axis 812 of the bracket antenna. As used herein, the term “substantially parallel” corresponds to a variation from true parallel by no more than 25 degrees.

It should also be noted that while a bracket antenna 302 is shown, bracket antenna 302′ presented in conjunction could likewise be employed with corresponding cut-outs in booster plate 304 to avoid making electrical contact with the mounting tabs 702 of the bracket antenna 302′ discussed in conjunction with FIG. 7.

FIG. 9 is a graphical representation 900 of an antenna frequency response of an embodiment. In particular, a frequency response is shown as experimentally measured which indicates a resonant peak at 13.62 MHz with a gain of −10.316 dBm and a Q of approximately 13.

FIG. 10 is a flow diagram 1000 of an embodiment of a method. In particular, a method is presented for use in conjunction with the functions and features described in conjunction with FIGS. 1-9. Step 1002 includes sending and receiving RF communications of a mobile communication device via a bracket antenna configured to form a structural portion of a back cover of the mobile communication device, wherein bracket antenna encloses at least one portion of an edge of the mobile communication device and at least one portion of the back side. Step 1004 includes providing a booster plate coupled to the mobile communication device and configured to electromagnetically interact with the bracket antenna to modify the antenna beam pattern.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. An antenna section comprising:
a bracket antenna configured to send and receive RF communications of a mobile communication device having a back side that is enclosed by a back cover, wherein the bracket antenna forms a structural portion of the back cover of the mobile communication device that encloses at least one portion of an edge of the mobile communication device and at least one portion of the back side; and
a booster plate coupled to the mobile communication device and configured to electromagnetically interact with the bracket antenna to modify an antenna beam pattern.

2. The antenna section of claim 1 wherein the mobile communication device wherein the RF communications include near-field communications of the mobile communication device.

3. The antenna section of claim 1 wherein the mobile communication device is a mobile telephone having a display screen and wherein the at least one edge includes a top edge of the mobile communication device when the display screen is in a portrait orientation.

4. The antenna section of claim 1 wherein the booster plate includes a foil member that is attached to the mobile communication device so as to be covered by a non-antenna portion of the back cover.

5. The antenna section of claim 1 wherein the booster plate has a longitudinal axis that is offset from and substantially parallel to a longitudinal axis of the bracket antenna.

6. The antenna section of claim 1 wherein the back cover includes a rim and wherein the bracket antenna forms at least a portion of the rim.

7. The antenna section of claim 1 wherein the structural portion of the back cover formed by the bracket antenna is exposed.

8. The antenna section of claim 1 wherein the bracket antenna includes a plurality of mounting tabs for attaching the bracket antenna to the mobile communication device.

9. The antenna section of claim 1 wherein the plurality of mounting tabs attach the bracket antenna to the mobile communication device via a plurality of screws, and wherein the plurality of mounting tabs are recessed so as to be covered by a non-antenna portion of the back cover.

10. The antenna section of claim 1 further comprising:
a matching network configured to couple the bracket antenna to a near-field communication transceiver of the mobile communication device.

11. An antenna section comprising:
a bracket antenna configured to send and receive RF communications of a mobile communication device having a back side that is enclosed by a back cover, wherein the bracket antenna forms a portion of the back cover of the mobile communication device that encloses at least one portion of an edge of the mobile communication device and at least one portion of the back side; and
a booster plate coupled to the mobile communication device and configured to electromagnetically interact with the bracket antenna to modify an antenna beam pattern.

12. The antenna section of claim 11 wherein the mobile communication device wherein the RF communications include near-field communications of the mobile communication device.

13. The antenna section of claim 11 wherein the mobile communication device is a mobile telephone having a display screen and wherein the at least one edge includes a top edge of the mobile communication device when the display screen is in a portrait orientation.

14. The antenna section of claim 11 wherein the booster plate includes a foil member that is attached to the mobile communication device so as to be covered by a non-antenna portion of the back cover.

15. The antenna section of claim 11 wherein the booster plate has a longitudinal axis that is offset from and substantially parallel to a longitudinal axis of the bracket antenna.

16. The antenna section of claim 11 wherein the back cover includes a rim and wherein the bracket antenna forms at least a portion of the rim.

17. The antenna section of claim 11 wherein the portion of the back cover formed by the bracket antenna is exposed.

18. The antenna section of claim 11 wherein the bracket antenna includes a plurality of mounting tabs for attaching the bracket antenna to the mobile communication device.

19. The antenna section of claim 11 wherein the plurality of mounting tabs attach the bracket antenna to the mobile communication device via a plurality of screws, and wherein the plurality of mounting tabs are recessed so as to be covered by a non-antenna portion of the back cover.

20. A method comprising:
sending and receiving RF communications of a mobile communication device via a bracket antenna configured to form a structural portion of a back cover of the mobile communication device, wherein bracket antenna encloses at least one portion of an edge of the mobile communication device and at least one portion of a back side of the mobile communication device; and
providing a booster plate coupled to the mobile communication device and configured to electromagnetically interact with the bracket antenna to modify an antenna beam pattern.
